(19) United States
(12) Patent Application Publication
(10) Pub. No.: US 2015/0055529 A1
(43) Pub. Date: Feb. 26, 2015

(54) METHOD AND APPARATUS FOR DYNAMICALLY MANAGING A NON-DISCONTINUOUS RECEPTION MODE SPECIFIC TO USER EQUIPMENTS, AND SYSTEM THEREOF

(71) Applicant: Samsung Electronics Co., Ltd., Suwon-si, Gyeonggi-do (KR)

(72) Inventors: Pradeep Krishnamurthy Hirisave, Bangalore (IN); Satish Nanjunda Swamy Jamadagni, Bangalore (IN); Sarvesha Anegundi Ganapathi, Bangalore (IN)

(21) Appl. No.: 14/370,485

(22) PCT Filed: Jan. 2, 2013
(86) PCT No.: PCT/KR2013/000006

§ 371 Date: Jul. 2, 2014

(30) Foreign Application Priority Data
Jan. 2, 2012 (IN) 29/CHE/2012

(51) Int. Cl. H04W 52/02; H04W 28/02; H04W 76/04; H04W 72/04

(52) U.S. Cl. CPC H04W 52/0216; H04W 72/042; H04W 28/0221; H04W 76/048; H04W 88/06
USPC 370/311

(57) ABSTRACT

The present invention provides a method, an apparatus, and a system for dynamically managing a non-discontinuous reception mode specific to user equipments. In one embodiment, a method includes obtaining statistical data associated with an ongoing data transfer session with a user equipment. Further, the method includes analysing the statistical data to determine a probability of establishing a new downlink TBF for a short time after the current TBF is released. The method also includes computing a non-DRX timer value for the ongoing data transfer session with the user equipment based on the analysis of the statistical data. Furthermore, the method includes transmitting a network message indicating the non-DRX timer value specific to the ongoing data transfer session to the respective user equipments. Moreover, the method includes operating in a non-DRX mode after the TBF is released and till the non-DRX timer value received in the network message is expired.

### TECHNICAL FIELD

The present invention relates to the field of wireless communication systems, and more particularly relates to method, an apparatus, and a system for dynamically managing a non-discontinuous reception (non-DRX) mode specific to user equipments.

### BACKGROUND ART

Third generation partnership project (3GPP) standards (e.g., 3GPP TS 44.060) specify five scenarios when a user equipment shall enter a non-DRX mode period:

1. At the transition from packet transfer mode to packet idle mode, the user equipment shall enter non-DRX mode period;

2. At transition from dual transfer mode to dedicated mode or the packet idle mode, the user equipment shall enter the transfer non-DRX mode period;

3. The user equipment operating in a network cell reselection (NC2) mode shall enter NC2 non-DRX period mode period when the user equipment sends a network control (NC) measurement report;

4. When initiating mobility management (MM) procedures for General Packet Radio Service (GPRS) attach and routing area update defined in 3GPP TS 24.008, the user equipment shall enter MM non-DRX mode period; and

5. When the user equipment receives a pre-notification for a multimedia broadcast/multicast service (MBMS) and MBMS session, the user equipment shall enter the MBMS non-DRX mode.

According to the 3GPP standards, after a temporary block flow (TBF) release, the user equipment reverts to a non-DRX mode. In the non-DRX mode, the user equipment has to decode all Common Control Channel (CCCH) or Paging Control Channel (PCCH) blocks. The user equipment operates in the non-DRX mode for a period equal to a non-DRX timer value. The user equipment operates in the non-DRX mode before entering the idle mode so that the downlink TBF can be established quickly if a base station wishes to initiate a new downlink TBF when a downlink TBF allocation is required to be communicated to the user equipment. In other words, the user equipment operates in the non-DRX mode for the non-DRX timer value to account for a high probability that a new downlink TBF will need to be established for a short time after the TBF is released.

Typically, the base station sets a maximum non-DRX timer value and provides the maximum non-DRX timer value to the user equipment during the initial registration procedure. The maximum non-DRX timer value is applicable for all user equipments connected to the base station in a cell. Thus, all the user equipments in the cell have to operate in a non-DRX mode after release of the TBF and till the expiry of the maximum non-DRX timer value irrespective of whether or not PCCH channels in the cell. Alternatively, the user equipment may set the non-DRX timer value as per 3GPP TS 24.008, 43.013, and 44.060. As a result, the battery of the user equipment is drained more quickly as the non-DRX mode requires more the battery power compared to the DRX mode or packet idle mode.

### DISCLOSURE OF INVENTION

### Technical Problem

An aspect of an exemplary embodiment of the present invention provides a method, an apparatus, and a system for dynamically managing a non-discontinuous reception (non-DRX) mode specific to user equipments.

### Solution to Problem

In accordance with one aspect of the present invention, there is provided a method for dynamically managing a non-discontinuous reception mode specific to a user equipment, the method comprises acquiring statistical data associated with an ongoing data transfer session between a user equipment and a base station, dynamically computing a non-DRX timer value corresponding to the ongoing data transfer session based on the statistical data, and transmitting the non-DRX timer value corresponding to the ongoing data transfer session to the user equipment so that the user equipment applies the non-DRX timer value to operate in at least one non-DRX state once a traffic block flow (TBF) corresponding to the ongoing data transfer session is released.

In accordance with another aspect of the present invention, there is provided an apparatus for dynamically managing a non-discontinuous reception mode specific to a user equipment, the apparatus comprises a processor, a memory coupled to the processor, wherein the memory comprises a non-DRX timer computation module configured for acquiring statistical data associated with an ongoing data transfer session with a user equipment, and dynamically computing a non-DRX timer value corresponding to the ongoing data transfer session based on the statistical data, and a transceiver configured for transmitting the non-DRX timer value corresponding to the ongoing data transfer session to the user equipment so that the user equipment applies the non-DRX timer value to operate in at least one non-DRX state once a traffic block flow (TBF) corresponding to the ongoing data transfer session is released.

In accordance with further aspect of the present invention, there is provided a system for dynamically managing a non-discontinuous reception mode specific to a user equipment, the system comprises a base station, and a plurality of user equipments communicatively connected to the base station, wherein the base station is configured for acquiring statistical data associated with an ongoing data transfer session with each of the plurality of user equipment, and wherein the base station is configured for dynamically computing a non-DRX timer value corresponding to the respective ongoing data transfer session based on the statistical data; and wherein the base station is configured for transmitting the non-DRX timer value corresponding to the respective ongoing data transfer session to each of the plurality of user equipments, and wherein the plurality of user equipments are configured for applying the respective non-DRX timer value to operate in at least one non-DRX state once a traffic block flow (TBF) corresponding to the associated ongoing data transfer session is released.

### BRIEF DESCRIPTION OF DRAWINGS

FIG. 1 illustrates a block diagram of a wireless network system, according to one embodiment.

FIG. 2 is a process flowchart illustrating an exemplary method of computing a non-Discontinuous Reception (DRX) timer value specific to the user equipment, according to one embodiment.

FIG. 3 is a process flowchart illustrating an exemplary method of storing the non-DRX timer value received from the base station, according to one embodiment.

FIG. 4 is a process flowchart illustrating an exemplary method of applying the non-DRX timer value specific to an ongoing data transfer session, according to one embodiment.

FIG. 5 is a block diagram of a base station showing various components for implementing embodiments of the present subject matter.

FIG. 6 is a block diagram of a user equipment showing various components for implementing embodiments of the present subject matter.

The drawings described herein are for illustration purposes only and are not intended to limit the scope of the present disclosure in any way.

### MODE FOR THE INVENTION

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

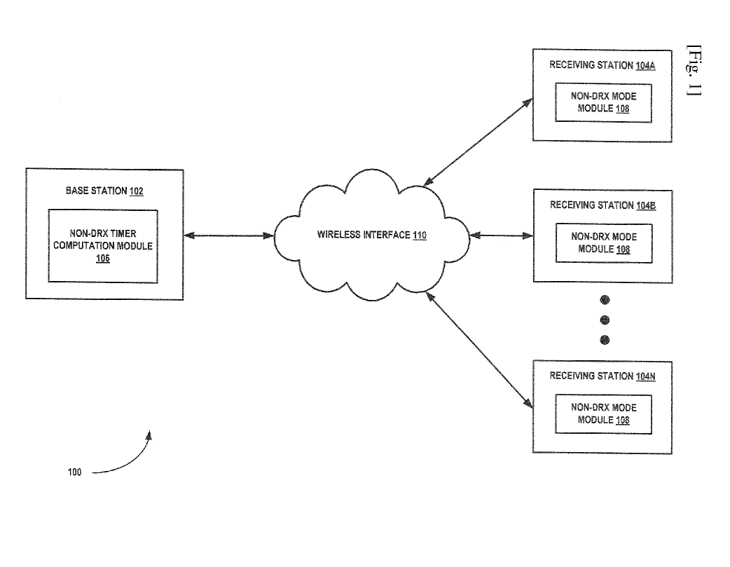

FIG. 1 illustrates a block diagram of a wireless network system 100, according to one embodiment. The wireless network system 100 includes a base station 102, and a plurality of user equipments 104A-N connected to the base station 102 via a wireless air interface 110. The base station 102 includes a non-DRX timer computation module 106 and each of the user equipments 104A-N includes a non-DRX mode module 108.

Generally, when the base station 102 has data to be transmitted to an user equipment (e.g., the user equipment 104A), a downlink temporary block flow (TBF) is established between the user equipment 104A and the base station 102. A TBF is a logical connection supporting data transmission on physical packets data channels between the user equipment 104A and the base station 102. The physical packet data channels are typically assigned to the user equipment 104A only for a time required to transmit data packets during the TBF. The TBF is maintained between the user equipment 104A and the base station 102 till all data packets are successfully transmitted. During this time, the base station 102 may send a plurality of radio link control (RLC)/media access control (MAC) data packets including logical link control data (LLC). Typically, in a final data packet, the base station 102 sets a final bit indicator value to ‘1’ and sends the final data packet to the user equipment 104A. The FBI indicates that all the data packets have been transmitted on the physical packets data channel. Once, the final data packet is received, the TBF is released. The user equipment 104A operates in a packet transfer mode from establishment of the TBF to the release of the TBF.

Upon releasing the TBF, the user equipment 104A enters a packet idle non-DRX mode prior to entering a packet idle DRX mode. The non-DRX mode enables the user equipment 104A in the packet idle mode to remain in full common control channels (CCCH) state, paging CCH (PCCH) state, or channel monitoring state and enables faster packet data transfer session establishment than processing paging messages based packet data transfer session setup. The user equipment 104A remains in the non-DRX mode till expiry of a non-DRX timer value. Upon expiry of the non-DRX timer value, the user equipment 104A enters the DRX mode and continues to operate in the DRX mode till a new TBF is established for subsequent data transfer. According to the present invention, the non-DRX timer computation module 106 computes a non-DRX timer value to be applied by the user equipment 104A based on type of ongoing data transfer session between the user equipment 104A and the base station 102. The DRX timer value indicates duration of a non-DRX mode period to be applied by the particular user equipment 104A in a cell when the ongoing data transfer session ends (i.e., the TBF is released). Since the nature of data traffic varies across the plurality of user equipments 104A-N in a cell, the base station 102 intelligently computes DRX timer separately for each of the plurality of user equipments 104A-N based on the respective ongoing data transfer session. The base station 102 indicates the specific DRX timer value to the user equipments 104A-N prior to releasing the TBF. Accordingly, the respective user equipments 104A-N enter the non-DRX mode once the TBF is released and operates in the non-DRX mode till the expiry of the specific non-DRX timer value. This helps saving battery power consumed by the respective user equipments 104A-N as the non-DRX timer value is specific to the ongoing data transfer session with the respective user equipments 104A-N and not common across the plurality of user equipments 104A-N in the cell.

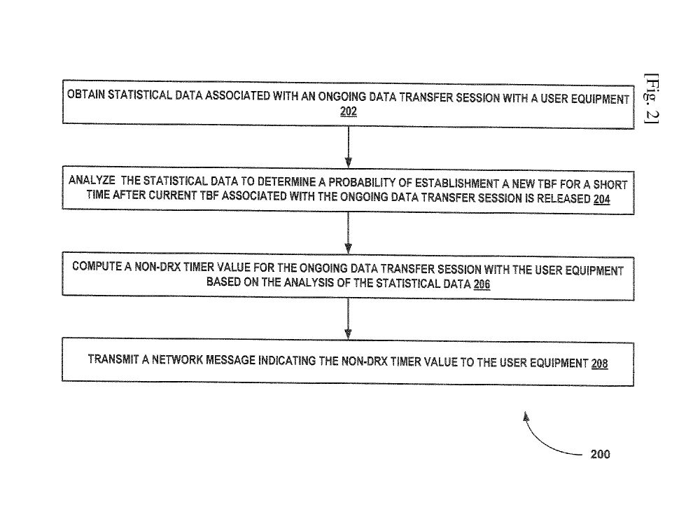

FIG. 2 is a process flowchart 200 illustrating an exemplary method of computing a non-DRX timer value specific to the user equipment 104A, according to one embodiment. At step 202, statistical data associated with an ongoing data transfer session with a user equipment (e.g., the user equipment 104A) is collected. In some embodiments, statistical data associated with an ongoing data transfer session is collected by sampling inter-arrival data associated with the user equipment 104A during the ongoing data transfer session. It can be noted that, the statistical data corresponds to parameters associated with the ongoing data transfer session such as application type, service type, TBF class, session history and so on.

For example, the application type may be an interactive Quality of Service (QoS) class application such as web application (e.g., social networking application, periodic update/tickers/advertisement application, Low bandwidth games and so on), E-mail, Voice over Internet Protocol, Push-to-talk, active maps, secured web access, news sites, Instant Messenger (IM) application and so on and a non-interactive QoS class application such as background class application, streaming and real-time QoS class applications. The traffic class may include different traffic types associated with the application and service. For example, the traffic class may relate to VOIP traffic class, Hypertext Transport Protocol (HTTP) traffic class and so on. The service type may be type of services running at the user equipment such as VOIP services, HTTP services and so on. Other parameters such as battery level, Quality of Service (QoS) requirement, push service status, and so on can also be considered for collecting statistical data.

At step 204, the statistical data is analysed to determine a probability of establishing a new TBF for a short time after the current TBF associated with the ongoing data transfer session is released. For example, the statistical data may be analysed using probability distribution technique known in the art or any other well known technique. It is desirable to analyse the statistical data associated with each ongoing data transfer session since the nature of data traffic during different ongoing data transfer sessions may lead to different number of setup and release of TBFs. The probability of a new TBF being established after the existing TBF is released can be precisely determined based on the statistical data of the respective ongoing data transfer sessions. At the same time, it also desirable for the base station 102 to ensure that the non-DRX mode period is set such that the battery power consumed during the non-DRX mode is kept minimal. Both the probability of establishment of a new TBF after the TBF is released and the minimal battery power consumption during the non-DRX mode can be achieved by computing the non-DRX mode period per ongoing data transfer session separately for each of the user equipments 104A-N connected to the base station 102.

At step 206, a non-DRX timer value for the ongoing data transfer session with the user equipment 104A is computed based on the analysis of the statistical data. At step 208, a network message indicating the non-DRX timer specific corresponding to the ongoing data transfer session is transmitted to the user equipment 104A. The network message may include packet uplink ack/nack message, packet downlink ack/nack message, packet TBF release message, immediate assignment message, a new dedicated message and so on. Exemplary packet uplink ack/nack message, packet TBF release message, and packet uplink ack/nack message carrying the non-DRX timer value specific to the user equipment are given in Tables 1 through 3 respectively.

In accordance to the above steps 202 through 208, in one exemplary implementation, the base station 102 may sample and store inter-arrival data associated with Radio Resource Connection (RRC) requests received during an ongoing data transfer session with the user equipment 104A. The base station 102 may then compute mean of the sampled inter-arrival data associated with the RRC connection requests. The mean of the sampled inter-arrival data constitutes a single statistical data attribute. The base station 102 may determine probability of re-establishing the TBF based on the statistical data attribute (e.g., the mean of sampled inter-arrival data for the ongoing data transfer session). The base station 102 may compute a non-DRX timer value applicable for a non-DRX mode following the ongoing data transfer session based on the probability of re-establishing the TBF. For example, a look-up table may be maintained at the base station 102 indicating various probability values and corresponding non-DRX timer values. Based on the probability value, the base station 102 may determine corresponding non-DRX timer value applicable for a DRX mode following the ongoing data transfer session with the user equipment 104A.

In some embodiments, the base station 102 computes the non-DRX timer value separately for every ongoing session with the user equipment 104A and transmits a network message carrying the non-DRX timer value before the TBF associated with said every ongoing data transfer session is released. In other embodiments, the base station 102 computes different non-DRX timer values for respective ongoing data transfer session with the plurality of user equipments 104A-N and transmits a network message carrying the respective non-DRX timer value to each of the plurality of user equipments 104A-N before the TBF associated with said each user equipment 104 is released. Since the base station 102 computes the non-DRX timer value per ongoing data transfer session with a particular user equipment based on the probability of reestablishment of the TBF during a non-DRX mode period, the base station 102 can ensure that battery power consumption at the particular user equipment during the non-DRX mode to be minimum.

In accordance to the above described method steps, the base station 102 can compute and provide number of states, time period, number of CCCH blocks to read, and/or inter CCCH period to read to each user equipment based on parameters associated with an ongoing data transfer session. In one example, number of states includes multiple non-DRX states such as non-DRX state 1, non-DRX state 2, and so on. In some embodiments, the base station 102 indicate multiple states and associated parameters (e.g., non-DRX timer value) to be applied in each of the multiple states to a user equipment in single message or in subsequent messages including a paging message once the respective user equipment enters one or more of the non-DRX states.

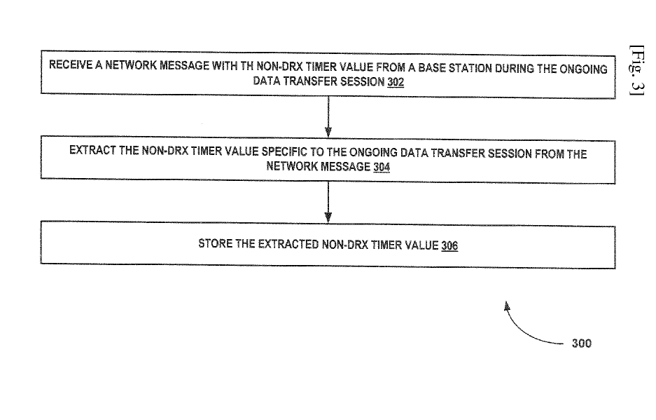

FIG. 3 is a process flowchart 300 illustrating an exemplary method of storing the non-DRX timer value received from the base station 102, according to one embodiment. At step 302, a network message with the non-DRX timer value is received from the base station 102 during an ongoing data transfer session. At step 304, the non-DRX timer corresponding to the ongoing data transfer session is extracted from the network message. At step 306, the non-DRX timer value is stored. For example, the user equipment 104A stores the non-DRX timer value in its memory.

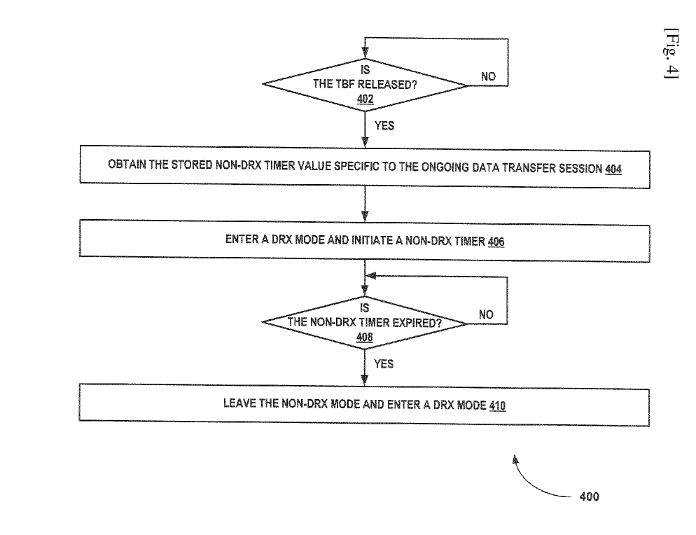

FIG. 4 is a process flowchart 400 illustrating an exemplary method of applying the non-DRX timer value specific to the ongoing data transfer session, according to one embodiment. At step 402, it is determined whether the TBF associated with the ongoing data transfer session is released. For example, the user equipment 104A determines whether the TBF is released if FBI field in a data packet received from the base station 102 is set to ‘1’. If the TBF is released, then at step 404, the stored non-DRX timer value specific to the ended data transfer session is obtained. At step 406, the user equipment 102 enters the non-DRX mode. Also, at step 406, a non-DRX timer is initiated based on the non-DRX timer value. At step 408, it is determined whether the non-DRX timer value is expired. If the non-DRX timer value is expired, then at step 410, the user equipment leaves the non-DRX mode and enters a DRX mode. If it is determined that the non-DRX timer value is not expired, then the step 408 is periodically performed till the non-DRX timer value gets expired. One skilled in the art would realise that the user equipments 104A-N connected to the base station 102 need not perform further computation of optimal non-DRX timer value prior to entering the non-DRX mode. This would help improve processing power and reduce battery power consumption at the respective user equipments 104A-N.

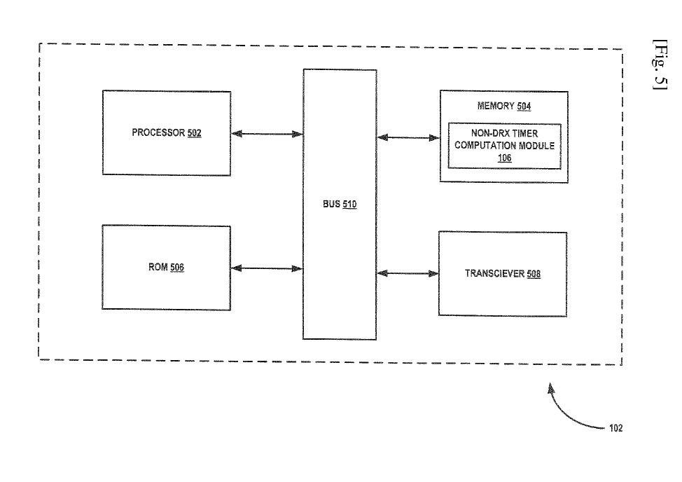

FIG. 5 is a block diagram of the base station 102 showing various components for implementing embodiments of the present subject matter. In FIG. 5, the base station 102 includes a processor 502, a memory 504, a read only memory (ROM) 506, a transceiver 508, and a bus 510.

The processor 502, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, and the like.

The memory 504 and the ROM 506 may be volatile memory and non-volatile memory. The memory 504 includes the non-DRX timer computation module 106 for computing a non-DRX timer value for each ongoing data transfer session with respective user equipments 104A-N, according to one or more embodiments described above. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like.

Embodiments of the present subject matter may be implemented in conjunction with modules, including functions, procedures, data structures, and application programs, for performing tasks, or defining abstract data types or low-level hardware contexts. The non-DRX timer computation module 106 may be stored in the form of machine-readable instructions on any of the above-mentioned storage media and may be executable by the processor 502. For example, a computer program may include machine-readable instructions capable of computing a non-DRX timer value for each ongoing data transfer session with respective user equipments 104A-N, according to the teachings and herein described embodiments of the present subject matter. In one embodiment, the program may be included on a compact disk-read only memory (CD-ROM) and loaded from the CD-ROM to a hard drive in the non-volatile memory.

The transceiver 508 may be capable of transmitting a network message with the respective non-DRX timer value to each of the user equipments 104A-N. The bus 510 acts as interconnect between various components of the base station 102.

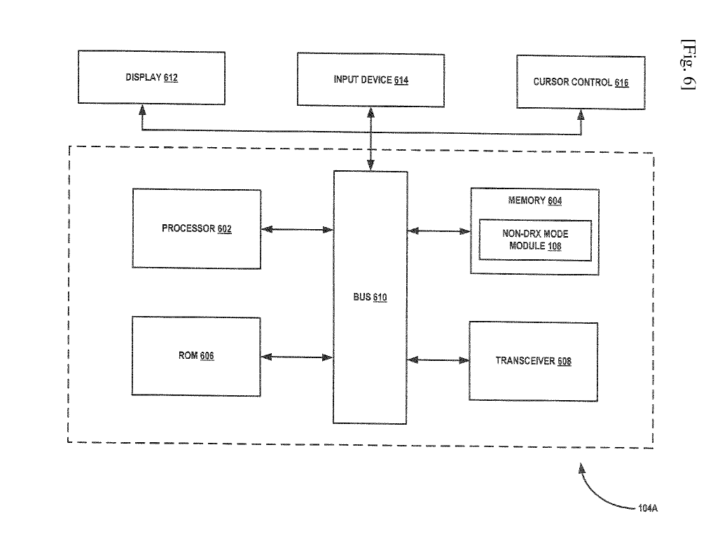

FIG. 6 is a block diagram of the user equipment 104A showing various components for implementing embodiments of the present subject matter. In FIG. 6, the user equipment 104 includes a processor 602, memory 604, a read only memory (ROM) 606, a transceiver 608, a bus 610, a display 612, an input device 614, and a cursor control 616.

The processor 602, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 602 may also include embedded controllers, such as generic or programmable logic devices or arrays, application specific integrated circuits, single-chip computers, smart cards, and the like.

The memory 604 and the ROM 606 may be volatile memory and non-volatile memory. The memory 604 includes the non-DRX mode module 108 for applying a non-DRX mode at the end of the ongoing data transfer session based on the non-DRX timer value received in the network message, according to one or more embodiments described above. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

Embodiments of the present subject matter may be implemented in conjunction with modules, including functions, procedures, data structures, and application programs, for performing tasks, or defining abstract data types or low-level hardware contexts. The non-DRX mode module 108 may be stored in the form of machine-readable instructions on any of the above-mentioned storage media and may be executable by the processor 602. For example, a computer program may include machine-readable instructions capable of applying a non-DRX mode at the end of the ongoing data transfer session based on the non-DRX timer value received in the network message, according to the teachings and herein described embodiments of the present subject matter. In one embodiment, the computer program may be included on a compact disk-read only memory (CD-ROM) and loaded from the CD-ROM to a hard drive in the non-volatile memory.

The transceiver 608 may be capable of receiving a network message carrying the non-DRX timer value specific to the ongoing data transfer session with the user equipment 104A. The bus 610 acts as interconnect between various components of the user equipment 104A. The components such as the display 612, the input device 614, and the cursor control 616 are well known to the person skilled in the art and hence the explanation is thereof omitted.

Apart from the embodiments described above, the base station 102 may also compute a ready timer for an ongoing data transfer session with a user equipment (e.g., the user equipment 104A) and communicated over the air interface prior to the release of TBF to respective user equipment 104A. The ready timer is computed based on user statistics, application type, session history or a combination of one or more such factors. A ready timer is a Non-access stratum (NAS) related timer used to maintain a GMM state in a ready state for a certain duration of inactivity. The importance of the ready state over a Paging Channel is that the base station 102 can directly send assignment messages rather than paging the user equipment 104A, thereby reducing the signaling overhead on network side and also battery consumption at user equipment. Conventionally, the ready timer was communicated once to the user equipment during initial registration procedure. It is desirable to have optimized values of ready timer, particular to a data transfer session/a TBF rather for any transaction after registration.

The present embodiments have been described with reference to specific example embodiments; it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

TABLE 1
< Packet Downlink Ack/Nack message content > ::=

| < DOWNLINK_TFI : bit (5) > | |
|---|---|
| < Ack/Nack Description : < Ack/Nack Description IE > > | |
| { 0 \| 1 < Channel Request Description : < Channel Request Description IE > > } | |
| < Channel Quality Report : < Channel Quality Report struct > > | |
| { null \| 0 bit** = <no string> | -- Receiver backward compatible with |

earlier version

| | |
|---|---|
| \| 1 | -- |

Additional contents for Release 1999

| {0 \| 1 < PFI : bit(7) > } | |
|---|---|
| { null \| 0 bit** = < no string > | -- Receiver backward compatible with earlier version |

| | |
|---|---|
| \| 1 | -- Additions for REL-5 |

{ 0 | 1 < Iu mode Channel Request Description : < Iu mode Channel Request Description IE

> > }

| { 0 \| 1 < RB id : bit (5) > } | |
|---|---|
| { 0 \| 1 < Timeslot Number : bit (3) > } | |
| { null \| 0 bit** = <no string> | -- Receiver backward compatible with earlier version |

| | |
|---|---|
| \| 1 | -- Additional contents |

for Release 6

| | | |
|---|---|---|
| { 0 \| 1 | < Extended Channel Request Description : | < Extended Channel |

Request Description IE > > } }

| | |
|---|---|
| { null \| 0 bit** = <no string> | -- Receiver backward compatible with earlier |

version

| | |
|---|---|
| \| 1 | -- Additional |

contents for Release 7

< EARLY_TBF_ESTABLISHMENT : bit (1) >

< padding bits > }

{ null | 0 bit** = <no string> -- Receiver backward compatible with

earlier version

| | |
|---|---|
| \| 1 | -- Additions for Rel-XYZ |

{ 0 | 1 <Page ReOrg Parameters : <Page ReOrg Parameters IE> >

}

< padding bits > }} };

< Page ReOrg Parameters IE >::=

| | |
|---|---|
| { 0 \| 1 | < Non_Drx_Timer : bit (3) > |

<Split Page Cycle code : bit(8)>
<split on CCCH : bit(2)>};

TABLE 2
< Packet TBF Release message content > ::=

| < PAGE_MODE : bit (2) > | |
|---|---|
| { | 0 < GLOBAL_TFI : Global TFI IE > |

| | |
|---|---|
| { | < UPLINK_RELEASE: bit (1) > |
| | < DOWNLINK_RELEASE : bit (1) > |
| | < TBF_RELEASE_CAUSE : bit (4) = { 0000 \| 0010 } > |
| | < padding bits > |

| | |
|---|---|
| { null \| 0 bit** = <no string> | -- Receiver backward compatible with |

earlier version

| | |
|---|---|
| \| 1 | -- Additions for Rel-XYZ |

{ 0 | 1 <Page ReOrg Parameters : <Page ReOrg Parameters IE> > }

< padding bits > }

! < Non-distribution part error : bit (*) = < no string > > }

! < Address information part error : bit (*) = < no string > > }

! < Distribution part error : bit (*) = < no string > > ;

< Page ReOrg Parameters IE > ::=

| | |
|---|---|
| { 0 \| 1 | < Non_Drx_Timer : bit (3) > |

<Split Page Cycle code : bit(8)>
<split on CCCH : bit(2)>};

TABLE 3
< Packet Uplink Ack/Nack message content > ::=

| < PAGE MODE : bit (2) > | |
|---|---|
| { | 00 < UPLINK_TFI : bit (5) > |

| | |
|---|---|
| { 0 | -- Message escape |

| ....... | |
|---|---|
| // GPRS part | |
| } | |
| \| 1 | -- |

Message escape bit used to define EGPRS message contents

{00

| | |
|---|---|
| { | < EGPRS Channel Coding Command : < EGPRS Modulation and Coding |

Scheme IE > >

| < RESEGMENT : bit (1) > | |
|---|---|
| < PRE_EMPTIVE_TRANSMISSION : bit (1) > | |
| < PRR RETRANSMISSION REQUEST : bit (1) > | |
| < ARAC RETRANSMISSION REQUEST : bit (1) > | |
| {0 \| 1 | < CONTENTION_RESOLUTION_TLLI : bit (32) > } |
| < TBF_EST : bit (1) > | |
| { 0 \| 1 | < Packet Timing Advance : < Packet Timing Advance IE > > } |
| { 0 \| 1 | < Packet Extended Timing Advance : bit (2) > } |
| { 0 \| 1 | < Power Control Parameters : < Power Control Parameters IE > |

> }

| | |
|---|---|
| { 0 \| 1 | < Extension Bits : Extension Bits IE > } |

-- sub-clause 12.26

| | |
|---|---|
| { | < EGPRS Ack/Nack Description : < EGPRS Ack/Nack |

Description IE > >

| | |
|---|---|
| 0 | -- The value ‘1’ was allocated in an earlier |

version of the protocol and shall not be used.

| } // | |
|---|---|
| { | null \| 0 bit** = <no string> -- Receiver backward compatible with |

earlier version

| | |
|---|---|
| \| 1 | -- |

Additions for Rel-5

{ 0 | 1 < CONTENTION_RESOLUTION Identifier extension : bit

(4) > }

{ 0 | 1 < RB Id : bit (5) > }
< padding bits > }

{ null | 0 bit** = <no string> -- Receiver backward compatible with

earlier version

| | |
|---|---|
| \| 1 | -- Additions for Rel-XYZ |

{ 0 | 1 <Page ReOrg Parameters : <Page ReOrg Parameters IE>

> }

< padding bits > }

! < Non-distribution part error : bit (*) = <no string> > }

! < Message escape :{ 01 | 10 | 11 } bit (*) = <no string> > }} -- Extended for future

changes

! < Address information part error : bit (*) = <no string> > }

! < Distribution part error : bit (*) = <no string> > ;

< Page ReOrg Parameters IE > ::=

| | |
|---|---|
| { 0 \| 1 | < Non_Drx_Timer : bit (3) > |

<Split Page Cycle code : bit(8)>
<split on CCCH : bit(2)>};

1. A method of managing a non-discontinuous reception mode to a user equipment, the method comprising:
acquiring statistical data associated with an ongoing data transfer session between the user equipment and a base station;
computing a non-DRX timer value corresponding to the ongoing data transfer session based on the statistical data; and
transmitting the non-DRX timer value corresponding to the ongoing data transfer session to the user equipment so that the user equipment applies the non-DRX timer value to operate in at least one non-DRX state once a traffic block flow (TBF) corresponding to the ongoing data transfer session is released.

2. The method of claim 1, wherein computing the non-DRX timer value corresponding to the ongoing data transfer session based on the statistical data comprises:
computing a probability of establishment of at least one new TBF during the at least one non-DRX state by analyzing the statistical data; and
computing a non-DRX timer value corresponding to the ongoing data transfer session based on the probability of establishment of at least one new TBF during the at least one non-DRX state.

3. The method of claim 2, wherein transmitting the non-DRX timer value corresponding to the at least one non-DRX state to the user equipment comprises:
transmitting the non-DRX timer value to the user equipment prior to releasing the established TBF.

4. The method of claim 1, further comprising:
receiving a capability to decode the non-DRX timer value specific to the ongoing data transfer session.

5. An apparatus comprising:
a processor;
a memory coupled to the processor, wherein the memory comprises a non-DRX timer computation module configured to:
acquire statistical data associated with an ongoing data transfer session with a user equipment; and
compute a non-DRX timer value corresponding to the ongoing data transfer session based on the statistical data; and
a transceiver configured to transmit the non-DRX timer value corresponding to the ongoing data transfer session to the user equipment so that the user equipment applies the non-DRX timer value to operate in at least one non-DRX state once a traffic block flow (TBF) corresponding to the ongoing data transfer session is released.

6. The apparatus of claim 5, wherein the non-DRX timer value is a duration of at least one non-DRX mode period to be applied by the user equipment at the end of the ongoing data transfer session.

7. The apparatus of claim 5, wherein the non-DRX timer value is a non-zero value.

8. The apparatus of claim 5, wherein the non-DRX timer value corresponding to the at least one non-DRX state is specific to the user equipment.

9. The apparatus of claim 5, wherein in computing the non-DRX timer value corresponding to the ongoing data transfer session based on the statistical data, the non-DRX timer computation module is configured to:
compute a probability of re-establishment of the TBF during the at least one non-DRX state by analyzing the statistical data; and
compute a non-DRX timer value corresponding to the ongoing data transfer session based the probability of re-establishment of the TBF during the at least one non-DRX state.

10. The apparatus of claim 9, wherein the transceiver is configured to transmit the non-DRX timer value to the user equipment prior to releasing the established TBF.

11. The apparatus of claim 5, wherein the non-DRX timer value is transmitted in a message selected from the group consisting of a packet uplink ACK/NACK message, a packet downlink ACK/NACK message, a packet TBF release message, and an immediate assignment message.

12. The apparatus of claim 5, wherein the non-DRX timer computation module is configured to receive a capability to decode the non-DRX timer value specific to the ongoing data transfer session.

13. A system comprising:
a base station; and
a plurality of user equipments communicatively connected to the base station,
wherein the base station is configured to:
acquire statistical data associated with an ongoing data transfer session with each of the plurality of user equipment;
compute a non-DRX timer value corresponding to the respective ongoing data transfer session based on the statistical data; and
transmit the non-DRX timer value corresponding to the respective ongoing data transfer session to each of the plurality of user equipments; and
wherein the plurality of user equipments are configured to apply the respective non-DRX timer value to operate in at least one non-DRX state once a traffic block flow (TBF) corresponding to the associated ongoing data transfer session is released.

14. The system of claim 13, wherein in computing the non-DRX timer value corresponding to the respective ongoing data transfer session based on the statistical data, the base station is configured to:
compute a probability of re-establishment of the TBF during the at least one non-DRX state by analyzing the statistical data; and
compute a non-DRX timer value corresponding to the ongoing data transfer session based the probability of re-establishment of the TBF during the at least one non-DRX state.

15. The system of claim 14, wherein the base station is configured to transmit the respective non-DRX timer value to each of the plurality of user equipments prior to releasing the associated TBF.

16. The system of claim 13, wherein the non-DRX timer value corresponding to the at least one non-DRX state is specific to at least one user equipment.

17. The method of claim 1, wherein the non-DRX timer value is a duration of at least one non-DRX mode period to be applied by the user equipment at the end of the ongoing data transfer session.

18. The method of claim 1, wherein the non-DRX timer value is a non-zero value.

19. The method of claim 1, wherein the non-DRX timer value corresponding to the at least one non-DRX state is specific to the user equipment.

20. The method of claim 1, wherein the non-DRX timer value is transmitted in a message selected from the group consisting of a packet uplink ACK/NACK message, a packet downlink ACK/NACK message, a packet TBF release message, and an immediate assignment message.
